(19) United States
(12) Patent Application Publication
(10) Pub. No.: US 2010/0018344 A1
(43) Pub. Date: Jan. 28, 2010

(54) Composite Hub for High Energy-Density Flywheel

(76) Inventors: Ward Spears, Essex, MA (US); Matthew Polimeno, Tewksbury, MA (US); David Ansbigian, Stoneham, MA (US); Richard Hockney, Lynnfield, MA (US)

Correspondence Address: PRITZKAU PATENT GROUP, LLC, 993 GAPTER ROAD, BOULDER, CO, 80303, US

(21) Appl. No.: 12/181,012

(22) Filed: Jul. 28, 2008

(51) Int. Cl. F16F 15/305; H02K 7/02

(52) U.S. Cl. 74/572.12

(57) ABSTRACT

A flywheel energy storage system emphasizing enhancements developed for space applications including development of a flywheel rotor system capable of achieving maximum energy density, while being capable of repeated high peak-power demands. Illustrated is a rotor system comprising a composite hub, capable of supporting an optimized high-speed composite rim and shaft, working in combination with a switched reluctance motor.

### FIELD OF THE INVENTION

The present invention relates generally to flywheel energy storage systems and particularly to enhancements developed for overall systems adapted for spacecraft applications including development of a flywheel energy storage system capable of achieving its maximum energy density, while being capable of repeated high peak-power demands, due to the design and development of a flywheel rotor system featuring a composite high-strain hub that would be capable of following a mass-optimized composite rim, while simultaneously satisfying the rotor-dynamic requirements of the active magnetic bearing.

### REFERENCES

In general within the art, descriptions of flywheel energy storage systems and their various related elements can be found in U.S. Pat. Nos. 5,614,777 set forth by Bitterly et al; 567,595, 5,708,312, 5,770,909, and 58,644,303 by Rosen et al; 3,860,300 and 4,147,396 by Lyman; 3,791,704 and 4,088,379 by Perper; 5,627,419 by Miller; 4,910,449 by Hiyama et al: 5,760,510 by Nomura et al: 5,777,414 by Conrad; 5,319,844 by Huang et al; 4,444,444 by Benedetti et al; 5,844,339 by Schroeder et al; 5,495,221, 5,783,885, 5,847,480, 5,861,690, and 5,883,499 by Post; 5,705,902 by Merritt et al; 5,044,944 and 5,311,092 by Fisher; 5,107,151 and 5,677,605 by Cambier et al; and 5,670,838 by Everton; plus 3,969,005, 3,989,324, 4,094,560, and 4,141,607 by Traut; and 4,799,809 by Kuroiwa. Published paper: “Design, Fabrication, and Testing of 10 MJ Composite Flywheel Energy Storage Rotors,” J. D. Herbst, S. M. Manifold, B. T. Murphy, J. H. Price, R. C. Thompson, and W. A. Walls, A. Alexander and K. Twigg, 1998 SAE Aerospace Power Systems Conference, Apr. 21-23, 1998, Paper #981282, pp. 235-244

### BACKGROUND OF INVENTION

This invention relates to electric energy storage, through power interface electronics and electromechanical energy conversion, in the inertia of a spinning flywheel, and by reciprocal means, stored kinetic energy conversion to electric power. The various component elements of typical flywheel systems include: A high-speed motor/generator with cooperative power electronics, magnetic bearings with electronic feedback control servos to stabilize the magnetic bearings, a composite flywheel rim integral with the motor/generator rotor and rotatable magnetic bearing elements to store kinetic energy, a composite hub and mechanical backup bearings that are not engaged during normal service.

As also illustrated in the above-referenced United States patents, such means as rechargeable electrochemical batteries offer some usages, but encounter significant problems involving key issues such as storage space, leakage and longevity. Therefore flywheel driven systems may offer distinct advantages over such systems. However, as flywheel energy storage system designs have evolved from smaller, physically limited structures with minimal storage capacity to the high capacity systems employing industrial sized magnetic members prevalent today, material restrictions and other such factors inherent with larger scale have arisen. Said considerations must be overcome in order to facilitate reaching the maximal energy storage and output to render flywheel energy storage systems a viable alternative.

In modern applications, failure of high capacity flywheel systems to reach maximum energy density and maintain capability of repeated high peak-power demands often is attributed to limitations of the hub component. Much of the problem centers around the materials utilized, as presently, hub components are normally comprised of high-strength metal, in order to meet with strength to weight requirements and other such considerations.

What is needed is a flywheel energy storage system capable of achieving its maximum energy density, while being capable of repeated high peak-power demands. What is needed is development of a composite hub capable for supporting an optimized high-speed composite rim.

What is needed is a composite high-strain hub, capable of following a mass-optimized composite rim, while simultaneously satisfying the rotor-dynamic requirements of the active magnetic bearing. Further, what is need is flywheel driven energy storage system wherein the motor mechanism comprises a switched reluctance design.

### SUMMARY OF THE INVENTION

The instant invention, as illustrated herein, is clearly not anticipated, rendered obvious, or even present in any of the prior art mechanisms, either alone or in any combination thereof. A composite hub design for flywheel energy storage system, adapted to compensate for the aforementioned drawbacks and limitations of metal hubs would afford significant improvement to numerous useful applications. Thus, the instant invention as illustrated herein, is clearly not anticipated, rendered obvious, or even present in any of the prior art mechanisms, either alone or in any combination thereof. Thus the several embodiments of the instant invention are illustrated herein. Composite hubs have been proposed which are manufactured using a filament-wound process (see reference published paper), but their performance is limited due to the material design limitations imposed by that processing method. The invention disclosed herein overcomes those limitations by employing more complex processing methods.

The primary object of the instant invention is to provide improved system performance regarding rotor systems, and in particular composite hubs, rims and shafts for flywheel energy storage systems (also referred to as a “FESS” within the industry). The instant invention finds basis in a commercially designed and implemented flywheel energy storage system which consists of a high-energy composite rotor which spins at high speed (greater than 20,000 RPM), in order to store kinetic energy. The flywheel rotor is basically a composite rim supported by a hub and shaft spinning on bearings in a vacuum. These bearings can be mechanical or magnetic, and may further comprise added touchdown capability. The shaft is driven by a fixed motor/generator.

During charging, the electric motor runs off of a power source and starts to spin the rim. Once the flywheel gains full speed, it spins freely with minimal losses. When the input power goes down, the motor/generator and an inverter convert the flywheel rotor's energy to a constant voltage power supply to the critical load. This imposes a load on the flywheel, gradually slowing it as kinetic energy is converted back to electric power.

Additionally, the instant invention relates particularly to flywheel energy storage systems and rotor systems therein developed for outer space relevance, including space-craft and satellite applications. Many existing flywheel systems utilize a composite rim and metallic hub. Thus, the metallic hub is the stress limiting part of the rotor, which prevents the carbon fiber composite rim from reaching its maximum capability at a significantly higher operating speed. During this project a composite hub has been designed that will allow the rim to run closer to its maximum stress capability resulting in a significantly more compact and lighter weight system.

Generally speaking, compared to battery energy storage systems, the FESS is more reliable, requires less maintenance, has a much longer life, high cyclic capability, operates with minimal degradation in performance in extreme environments, and eliminates environmental problems associated with disposal of batteries. The flywheel advantage begins where battery performance falls off. During ride-through and distributed generation use, electrical systems can experience multiple charge and discharge cycles even within one minute. Flywheels are not sensitive to high rates of charge and discharge, beyond checking that the torsional stresses are acceptable and the parts won't slip; and such rates have no noticeable effects on the life of the flywheel. In fact, the greatest overall efficiency for a flywheel is achieved at high charge and discharge rates.

If the battery rapidly discharges, it will only be able to extract a small percentage of its stored energy and more batteries may be needed to meet power and life requirements to account for this. In comparison, flywheels are relatively insensitive to deep discharge. The typical depth of a flywheel discharge is 75% to 90% of the stored energy and there are only minor effects on life due to these depths of discharge. Flywheels will also interface with any primary energy device on a space platform such as photovoltaic cells, fuel cells, or chemical batteries, improving their overall efficiency and energy density.

The most important advantage is that flywheels can be designed to have more than 100,000 charge and discharge cycles. Batteries have a typical life cycle time below 1,000 charge/discharge cycles. In comparison, a flywheel is designed for many thousands of cycles with minimal degradation in performance of life. The discharge time of a flywheel is the time it takes for the flywheel to decelerate from its maximum speed at full rated power. In general and unlike batteries, flywheels are well suited for equal charge and discharge rates. Under cyclic conditions, the energy-to-weight ratio of a chemical battery will be significantly less, possibly less than half, of the claimed energy density, whereas the flywheel's energy-to-weight capacity would remain nearly constant under these same conditions.

Thus particularly, one salient objective of the instant invention includes development of a flywheel energy storage system capable of achieving its maximum energy density, while additionally being capable of repeated high peak-power demands. And thus, the key to achieving this objective has been found to be the development of a composite hub capable of supporting an optimized high-speed composite rim. However, herein, designed to work in conjunction with the system featuring a composite hub, numerous advancements have been achieved as will be herein disclosed.

The disclosure herein represents a energy storage flywheel system design with an objective to develop a system capable of achieving its maximum energy density, while being capable of sustaining repeated high peak-power demands. The key to achieving this objective is the development of a composite hub capable of supporting an optimized high-speed composite rim. Development was based upon an existing flywheel system, which as was the industry norm prior to the instant developments, utilized a composite rim and metal hub. The metal hub, above stated to be found as the stress limiting portion of the rotor system, and prevented the carbon fiber composite rim from reaching its maximum capability at a significantly higher operating speed. Through the developments featured herein, a composite hub that will allow the rim to run closer to its maximum stress capability resulting in a more compact and lighter weight system has been designed.

It is an additional object of the instant invention to illustrate a flywheel energy storage system capable of achieving its maximum energy density, while being capable of repeated high peak-power demands. It is an object of the instant invention to illustrate the development of a composite hub capable of supporting an optimized high-speed composite rim.

It is an object of the present invention to illustrate a flywheel energy storage system comprising a novel rotor system comprising a composite hub, composite rotor and metal shaft, utilized in combination with a switched reluctance motor system, which afford the system the capability of achieving its maximum energy density.

It is an object of the instant invention to illustrate a flywheel energy storage system properly adaptable for spacecraft, satellite and other outer space applications. It is an object of the instant invention to illustrate a flywheel energy storage system wherein all parameters and usage of state of the art material on individual components are maximized in order to not only to maximize the composite hub performance, but also to qualify as a complete overhaul in comparison to prior systems.

Accordingly, an improved flywheel energy storage system and accompanying enhancements its component elements are herein described, which achieve these objectives, plus other advantages and enhancements. These improvements to the art will be apparent from the following description of the invention when considered in conjunction with the accompanying drawings wherein there has thus been outlined, rather broadly, the more important features of the flywheel energy storage system in order that the detailed description thereof that follows may be better understood, and in order that the present contribution to the art may be better appreciated.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention. Other features and advantages of the present invention will become apparent from the following description of the preferred embodiment(s), taken in conjunction with the accompanying drawings, which illustrate, by way of example, the principles of the invention.

### BRIEF DESCRIPTION OF THE SEVERAL VIEWS OF THE DRAWING

FIG. 1 is an isometric view of the composite hub mechanism;

FIG. 2 is an isometric cross-sectional view of the hub illustrating the differing layers of the hub;

FIG. 3 incorporates three isometric cross section views of the upper cylindrical portion of the hub, illustrating the differing layers of the hub;

FIG. 4 is an isometric view of the composite rim mechanism;

FIG. 5 is a cross sectional view of the composite rim mechanism;

FIG. 6 is an isometric cross sectional view of the shaft mechanism;

FIG. 7 is an isometric cross sectional view of the hub, rim and shaft mechanism;

FIG. 8 is cross-sectional view of the 6-4 switched reluctance machine design;

FIG. 9 is a side cutaway view of the overall system illustrating the hub, rim, shaft and switched reluctance machine;

FIG. 10A is a side cutaway view of the overall hub;

FIG. 10B is a side cross-section view of the upper cylindrical portion hub, illustrating the differing layers of the hub;

FIG. 10C is a side cross-section view of the lower cylindrical portion hub, illustrating the differing layers of the hub; and,

FIG. 10D is an isometric side view of the overall hub.

### DETAILED DESCRIPTION OF THE SEVERAL EMBODIMENTS

The detailed description set forth below in connection with the appended drawings is intended as a description of presently-preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as flywheel systems with magnetic bearing used in a variety of applications.

The instant composite hub and supportive components illustrated herein represent the fruits of a design effort pointed at development a flywheel energy storage system capable of achieving its maximum energy density, while being capable of repeated high peak-power demands. With the advent of designing a composite hub or rim in order to develop a flywheel energy storage system capable of achieving its maximum energy density, the instant inventive process spawned an aggressive overall redesign for flywheel energy storage systems. The following materials represent the contents of the report generated from this study and development effort.

Prior developed commercial flywheel energy storage system (FESS) consisted of a high-energy composite rotor inside a sealed vacuum chamber, which spins at high speed (greater than 20,000 RPM) to store kinetic energy. The flywheel rotor is basically a composite rim supported by a hub and shaft spinning on bearings in a vacuum. These bearings can be mechanical or magnetic with added touchdown capability. The shaft is driven by a fixed motor/generator. During charging, the electric motor runs off of a power source and starts to spin the rim. Once the flywheel gains full speed, it spins freely with minimal losses. When the input power goes down, the motor/generator and an inverter convert the flywheel rotor's energy to a constant voltage power supply to the critical load. This imposes a load on the flywheel, gradually slowing it as kinetic energy is converted back to electric power.

The objective was to develop a flywheel energy storage system capable of achieving its maximum energy density, while being capable of repeated high peak-power demands. The key to achieving this objective is the development of a composite hub capable of supporting an optimized high-speed composite rim. The existing flywheel systems use a composite rim and aluminum hub. The aluminum hub has historically been the stress limiting part of the rotor system and thus prevented the carbon fiber composite rim from reaching its maximum capability at a significantly higher operating speed. During this project a composite hub has been designed that will allow the rim to run closer to its maximum stress capability resulting in a more compact and lighter weight system.

Compared to conventional battery energy storage systems, the FESS is more reliable, requires less maintenance, has a much longer life, high cyclic capability, operates with minimal degradation in performance in extreme environments, and eliminates environmental problems associated with disposal of batteries. The flywheel advantage begins where battery performance falls off. During ride-through and distributed generation use, electrical systems can experience multiple charge and discharge cycles even within one minute. Flywheels are not sensitive to high rates of charge and discharge, beyond checking that the torsional stresses are acceptable and the parts won't slip; and such rates have no noticeable effects on the life of the flywheel. In fact, the greatest overall efficiency for a flywheel is achieved at high charge and discharge rates.

If the battery rapidly discharges, it will only be able to extract a small percentage of its stored energy and more batteries may be needed to meet power and life requirements to account for this. In comparison, flywheels are relatively insensitive to deep discharge. The typical depth of a flywheel discharge is 75% to 90% of the stored energy and there are only minor effects on life due to these depths of discharge. Flywheels will also interface with any primary energy device on a space platform such as photovoltaic cells, fuel cells, or chemical batteries, improving their overall efficiency and energy density.

Possibly the most important advantage is that flywheels can be designed to have more than 100,000 charge and discharge cycles. Batteries have a typical life cycle time below 1,000 charge/discharge cycles. In comparison, a flywheel is designed for many thousands of cycles with minimal degradation in performance of life. The discharge time of a flywheel is the time it takes for the flywheel to decelerate from its maximum speed at full rated power. In general and unlike batteries, flywheels are well suited for equal charge and discharge rates. Under cyclic conditions, the energy-to-weight ratio of a chemical battery will be significantly less, possibly less than half, of the claimed energy density, whereas the flywheel's energy-to-weight capacity would remain nearly constant under these same conditions.

The instant effort has yielded a novel design of a high-strain hub, capable of following a mass-optimized composite rim, while simultaneously satisfying the rotor-dynamic requirements of an active magnetic bearing system. Several candidate hubs were analyzed, and a flywheel system concept was developed with the selected hub, based on baseline system requirements for energy density characteristics were defined for the proposed configuration.

The instant effort comprised designing a high-strain hub that would be capable of following a mass-optimized composite rim, while simultaneously satisfying the rotor-dynamic requirements of the active magnetic bearing. Several candidate hubs were analyzed, and a flywheel system concept was developed with the selected hub, based on baseline system requirements. Energy density characteristics were defined for the proposed configuration. The results of this effort illustrate that a composite hub can be designed that matches the strain at the ID of the Rim, allowing maximum energy density from the system. Further, the recommended configuration based on the analysis is non-geodesic filament wound hub. More specifically, the following parameters need be met in order to maximize hub configuration:
Shallow cone angle (30 degrees)
Circumferential fibers in several layers and axial fibers in one layer
Toray T1000G fibers or M46J fibers with a Polyurethane resin.
Radius ratio of less than 2 to 1.

Illustrated herein, a flywheel rotor system for a flywheel energy system comprising a composite hub mechanism, a composite rim mechanism, and a shaft mechanism. The composite hub mechanism further comprises a plurality of sections comprising an upper substantially cylindrical portion, a median substantially conical portion and a lower substantially cylindrical portion; wherein said upper substantially cylindrical portion is in radial communication with said median substantially conical portion; wherein said median substantially conical portion is in radial communication with said lower substantially cylindrical portion; and wherein each of said plurality of sections comprise a multiplicity of layers.

The composite hub mechanism further comprises a plurality of sections comprising an upper substantially cylindrical portion, a median substantially conical portion and a lower substantially cylindrical portion; wherein said upper substantially cylindrical portion is in radial communication with said median substantially conical portion; wherein said median substantially conical portion is in radial communication with said lower substantially cylindrical portion; and wherein each of said plurality of sections comprise three layers. The first of the three layers comprise an eight ply, T1000G/polyurethane five mil thick prepreg tape with a fiber volume of 55 percent and a fiber angle of 0 degrees, where 0 degrees is the direction of the spin axis. The second layer comprises a 0.005 inch film adhesive. The third layer comprises a thirty two ply, T1000G/polyurethane five mil thick prepreg tape with a fiber volume of 67 percent and fiber angle of 90 degrees, where 90 degrees is the circumferential direction.

The composite hub's upper substantially cylindrical portion comprises six layers. The forth layer comprises a twenty ply, M46J/polyurethane five mil thick prepreg tape with a fiber volume of sixty seven percent and fiber angle of 90 degrees. The sixth layer comprises a twenty ply, M46J/polyurethane five mil thick prepreg tapes with a fiber volume of sixty seven percent and fiber angle of 90 degrees. The sixth layers comprises a twenty ply, M46J/polyurethane five mil thick prepreg tape with a fiber volume of sixty seven percent and fiber angle of 90 degrees.

The composite hub lower substantially cylindrical portion possesses three layers and the first layer comprises a thickness of substantially 0.04 of an inch. The second layer comprises a thickness of substantially 0.005 of an inch. Layer three of said three layers comprises a thickness of substantially 0.16 of an inch; the composite hub's upper substantially cylindrical portion comprises six layers. Layer four of said two layers comprises a thickness of substantially 0.10 of an inch. The fifth layer comprises a thickness of substantially 0.10 of an inch, and the sixth layer comprises a thickness of substantially 0.10 of an inch. The composite hub's median portion comprises a 30 degree angle from the spin axis. Below is a diagram of the one parameters of one embodiment of the instant hub.

The required complex construction of the composite hub herein cannot be achieved with a filament winding manufacturing process. The preferred baseline manufacturing approach for manufacture is hand lay-up with unidirectional prepreg for this hub design. The prepreg approach allows better control for resin content, as the instant design illustrates the need to vary fiber type, fiber volumes, and fiber direction in the lay-up to achieve optimal performance. The combination of resin variation and unidirectional fibers offer a low weight, high strength approach; which in turn, maximizes the energy storage performance.

The matrix can be thermoset or thermoplastic in nature. While the composite rim can use a conventional epoxy system, the complex stress/strain requirements placed on the hub (the key component of the system to allow for minimum mass) require a unique polyurethane matrix. The matrix must have both the mechanical properties noted in Table 1, as well as the characteristics required to manufacture pre-impregnated tape (or “prepreg”).

TABLE 1
Required hub matrix properties

| Characteristic | Property Range |
|---|---|
| Tensile strength | 55-62 MPa (8-9 ksi) |
| Tensile modulus | 200-345 MPa (30-50 ksi) |
| Density | 1.2 gm/cc |
| Fracture toughness | 1.3 MPa√m (1200 psi√inch) |
| Glass transition temperature | >100° C. |

To optimize performance, the hub requires a polyurethane based prepreg where the layers will have different types of fibers and fiber volume fractions. Although filament winding is the commonly used technique for cylindrical shapes, optimization of the hub requires a fiber angle that is currently outside manufacturing capability using a wet wound process. None of the manufacturers are currently fabricating any polyurethane prepreg with the properties as specified in the instant hub design. One possible method entails polyurethane formulation and polyurethane reaction injection molding (RIM) technology. RIM is a plastics-forming process (similar to thermoplastic injection molding) that uses molds to form virtually anything from a very flexible foam-core part to a rigid solid part.

Truly, these composite systems are not prepreg and the primary applications of these composite systems are in the automotive industry. Further in consideration is a thermoplastic polyurethane matrix for the particular design, as well as to manufacture the prepreg. Some process limitations do however exist, such as the requirement that the specified resin needs be rendered into a fine powder form (resin, already in pellet form, can be ground under cryogenic condition) and the carbon fibers need to be unsized for adhesion reasons. To date, Hytrel 6356 and Texin 260 have been identified as two potential resin systems that meet the instant requirements.

Once the proper matrix is defined and pre-impregnated tape is manufactured, templates can be established for cutting, and the material layers would be staggered for butt joint considerations. A vacuum debulk cycle would be used every three layers to consolidate the layers, limit wrinkling and to alleviate void content concerns. The part would then be autoclave cured and post cured, as required. The associated manufacturing process flow is shown in Table 2.

TABLE 2
Hand Lay-up Process Flow

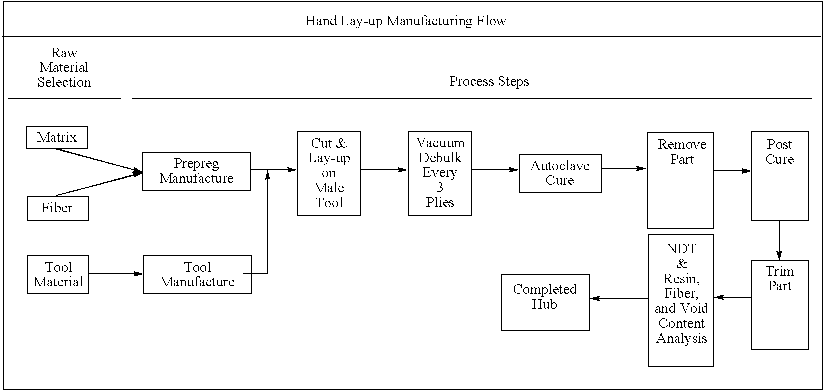

An alternative approach is resin transfer molding, as illustrated in Table 3. Utilization of such a method will be required if the matrix selection has a very short out time, too short to be used in the preferred baseline approached discussed above. Resin transfer molding requires a dry fabric or braided form be placed into a close mold, into which resin is “transferred” and cured to produce the part geometry.

In the instant design, the dry fiber pre-form will be braided over the tool. This will add weight to the design because braiders cannot produce the 0 and 90 degree optimal lay-up, requiring off axis plies with more fiber volume over the hand lay-up approach. The braided pre-form would be placed onto a male tool, then a female tool would be added and vacuum applied to remove air in this closed, matched tooling approach. Resin would be injected into the system and cured. Post curing may be utilized if necessary, after removal of the cured part from the tool. Parameters critical to utilization of the above-described method are properly locating the inlet, outlet and vent ports in order to limit porosity. Due to this added non-recurring process development, cost can only be recuperated with higher production rates than anticipated with this application. Thus, due to these complexities with resin transfer molding, hand lay-up is the preferred method herein.

TABLE 3
Resin Transfer Molding Process Flow

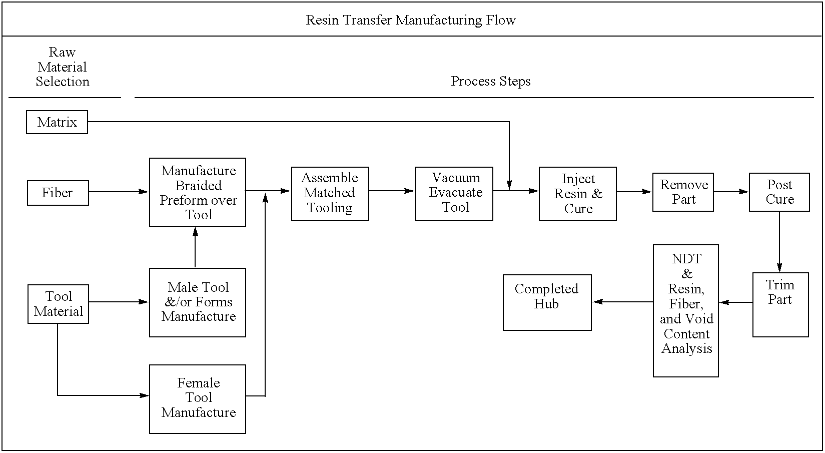

Fiber placement has also been considered and is a viable manufacturing approach, as seen in Table 4. For high volume production rates, this method presents an excellent alternative to hand lay-up as the added cost to slit the material and development of the tooling and manufacturing steps, hand lay-up is preferred over fiber placement at low volumes. In fiber placement, spools of slit tape are placed by the fiber placement head by feed rollers onto the part contour or mandrel. The head also cuts the slit tape, once the tape is in the proper location. The mandrel does not pull the material onto itself, as in filament winding, and is not required to turn. In our case, the geometry indicates that the mandrel would turn as the fiber placement head places material onto the mandrel.

TABLE 4
Fiber Placement Process Flow

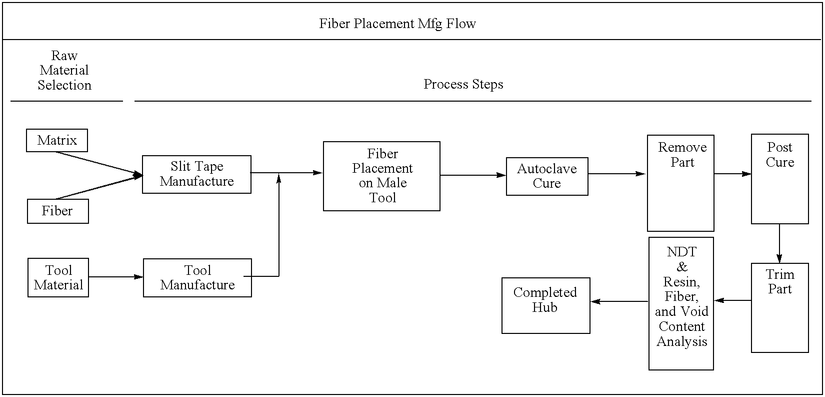

Filament winding had been considered as an alternative manufacturing process. Filament winding applies material onto a spinning geometry (mandrel) to build the part. For wet winding, spools of fiber are pulled through a resin bath by the spinning mandrel. Fiber tension, resin wet out in the bath, and viscosity of the resin are key control characteristics for those skilled in the process. Due to the contour of the hub, the fiber will slip down the OD and prevents manufacture via filament winding. This is due to the tension on the mandrel surface because the mandrel pulls the fiber onto itself. Due to the slope on the part, this tension would cause the fiber to slide down the surface. With prepreg winding, the fiber is already impregnated with resin, for better resin content control, and supplied in a slit tape, which is wound onto a mandrel.

This approach is better than wet winding as steeper angles can be achieve, but still requires the axial plies to be hand or fiber placed prior to application of bias plies. Fiber placement places the fiber onto the surface, so there is no tension and inertia to slide. With any of the above manufacturing approaches, once the part is formed, it would then be trimmed, non-destructively tested and inspected prior to shipment.

Thus, the instant invention has produced a lightweight flywheel energy storage system design using a composite hub. The hub is the key to achieving this objective because it is capable of supporting an optimized high-strain composite rim while achieving the necessary rotor-dynamic performance. This hub/rim combination was then incorporated into a complete system with high power motor/generator and power electronics, active magnetic bearings, and mounting structure. The rotor-level goal of 100 W-hr/kg is achieved while considering both launch and on-orbit environments. The system level goal of 75 W-h/kg would be met if the rim length were corrected for the predicted power conversion efficiency: the efficiency used to size the rim was 85%, and the predicted efficiency is over 93%.

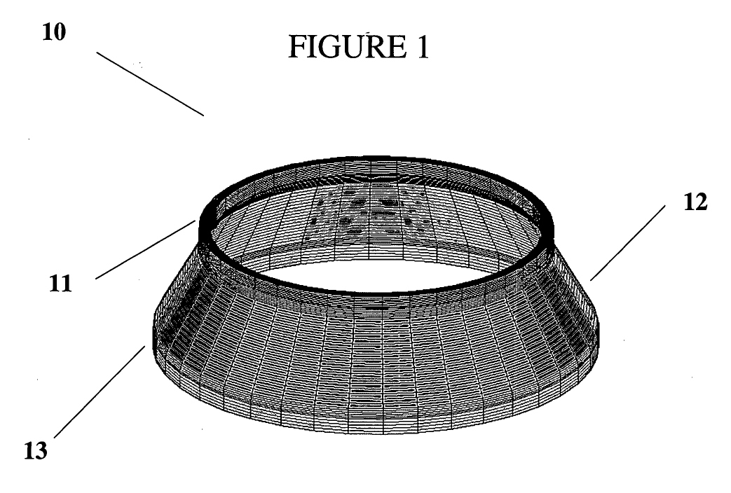

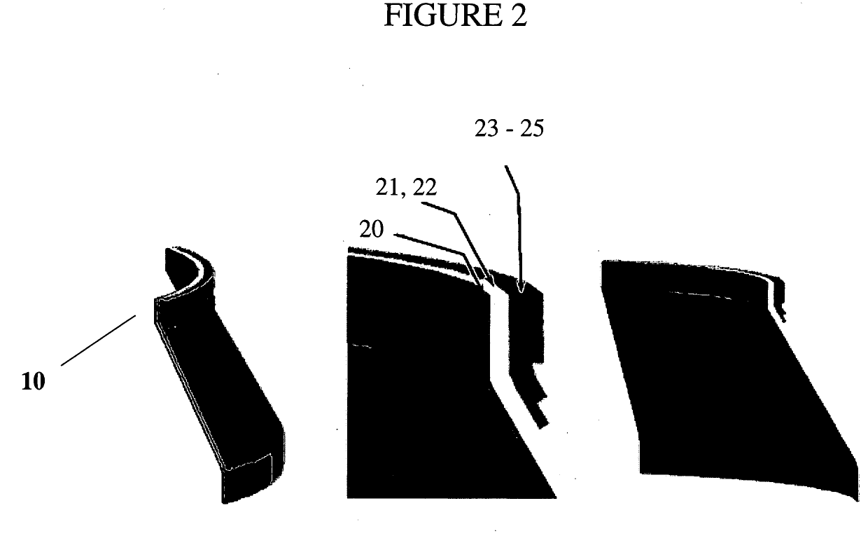

In addition to the several figures and tables interspersed within the body of the specification, the following figures further expound upon portions of the invention depicted herein. FIG. 1 is an isometric view of the composite hub mechanism. FIG. 2 is an isometric cross-sectional view of the hub 10 illustrating the differing sections comprising an upper substantially cylindrical portion 11, a median substantially conical portion 12 and a lower substantially cylindrical portion 13; wherein said upper substantially cylindrical portion 11 is in radial communication with said median substantially conical portion 12; wherein said median substantially conical portion 12 is in radial communication with said lower substantially cylindrical portion 13; and wherein each of said plurality of sections comprise a multiplicity of layers.

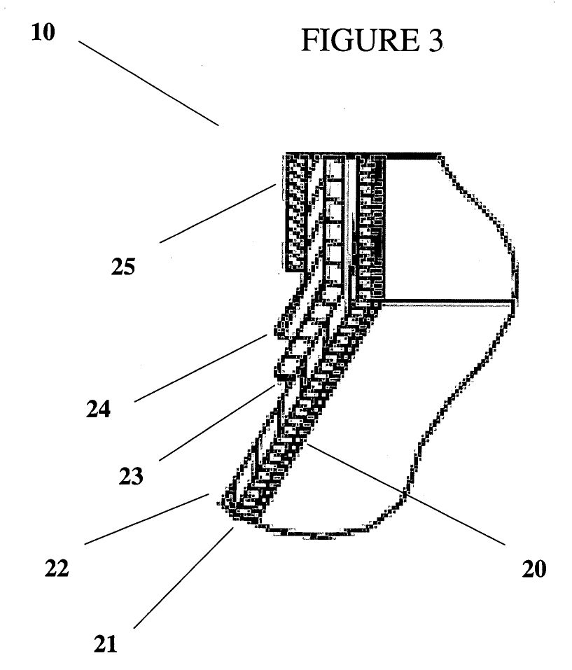

FIG. 3 is an exploded cross-section view of the upper portion of the hub mechanism 10, illustrating the differing layers of the hub as local to the differing sections of the hub mechanism 10. While the median substantially conical portion 12 and a lower substantially cylindrical portion 13 comprise only three layers, the first layer 20, second layer 21, and third layer 22 respectively, the upper substantially cylindrical portion 11 of the hub comprises six layers. The first layer 20 of the two layers comprise an eight ply, T1000G/polyurethane five mil thick prepreg tape with a fiber volume of 55 percent and a fiber angle of 0 degrees. The second layer 21 comprises a 0.005 inch film adhesive. The third layer 22, comprises a thirty two ply, T1000G/polyurethane five mil prepreg tape with a fiber volume of 67 percent and fiber angle of 90 degrees.

The fourth layer 23, which applies only to the upper substantially cylindrical portion 11 of the hub, comprises a twenty ply, M46J/polyurethane five mil thick prepreg tape with a fiber volume of sixty seven percent and fiber angle of 90 degrees. The fifth layer 24, which again applies only to the upper substantially cylindrical portion 11 of the hub, comprises a twenty ply, M46J/polyurethane five mil thick prepreg tapes with a fiber volume of sixty seven percent and fiber angle of 90 degrees. Finally, the sixth layer 25, which applies only to the upper substantially cylindrical portion 11 of the hub, comprises a twenty ply, M46J/polyurethane five mil thick prepreg tape with a fiber volume of sixty seven percent and fiber angle of 90 degrees.

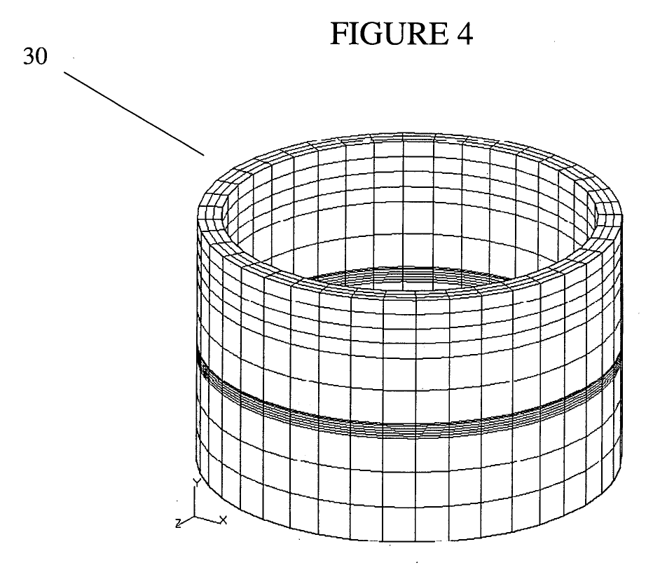

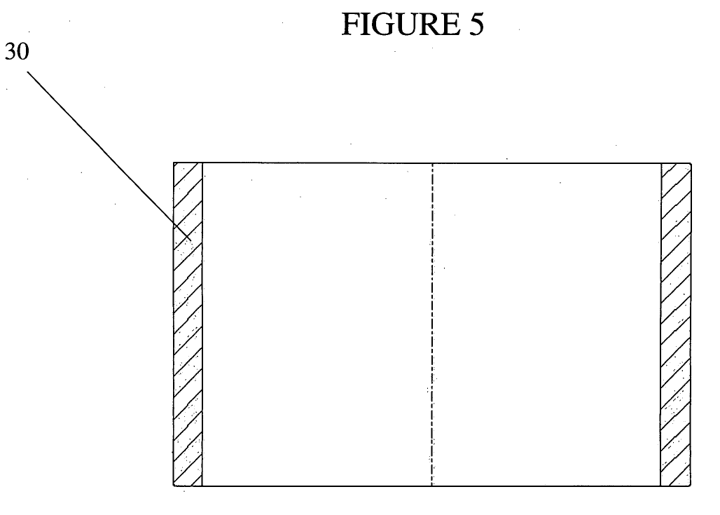

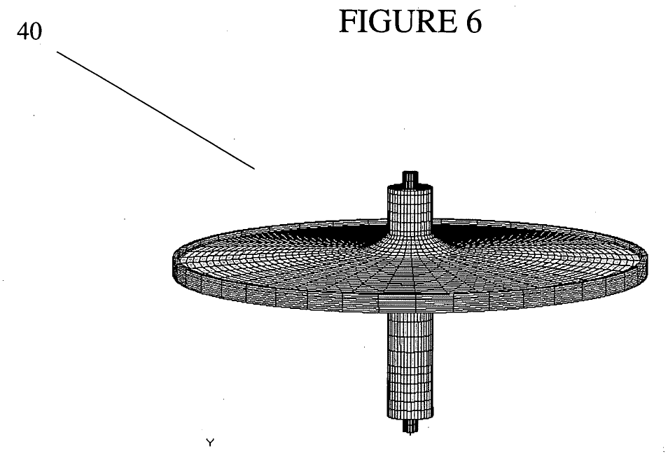

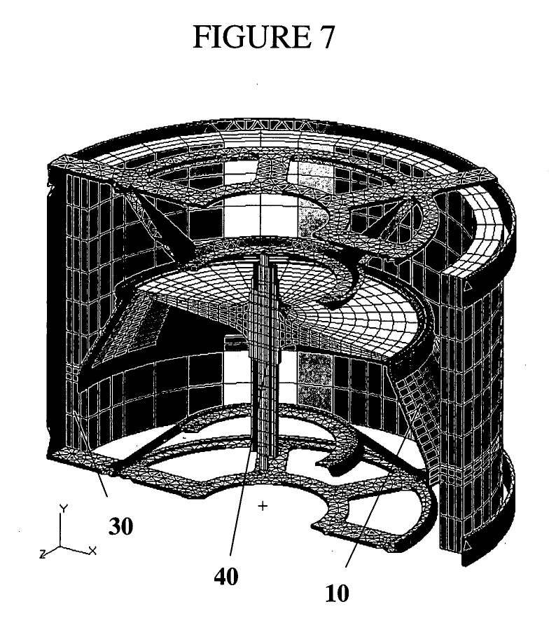

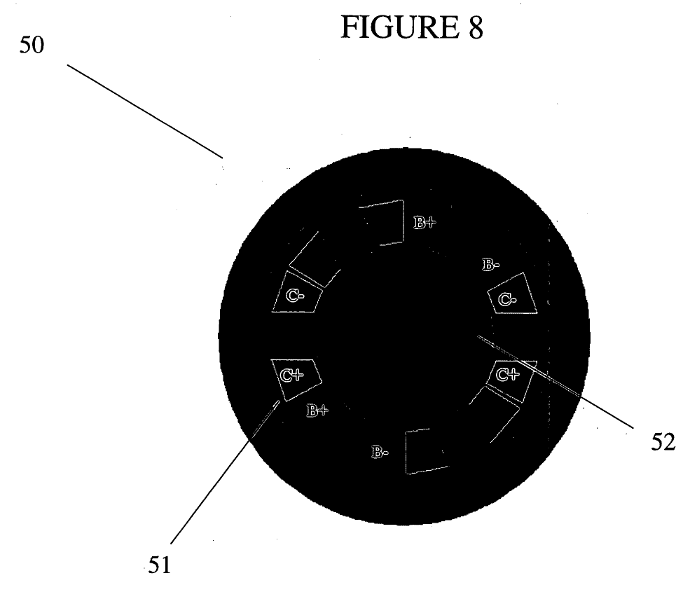

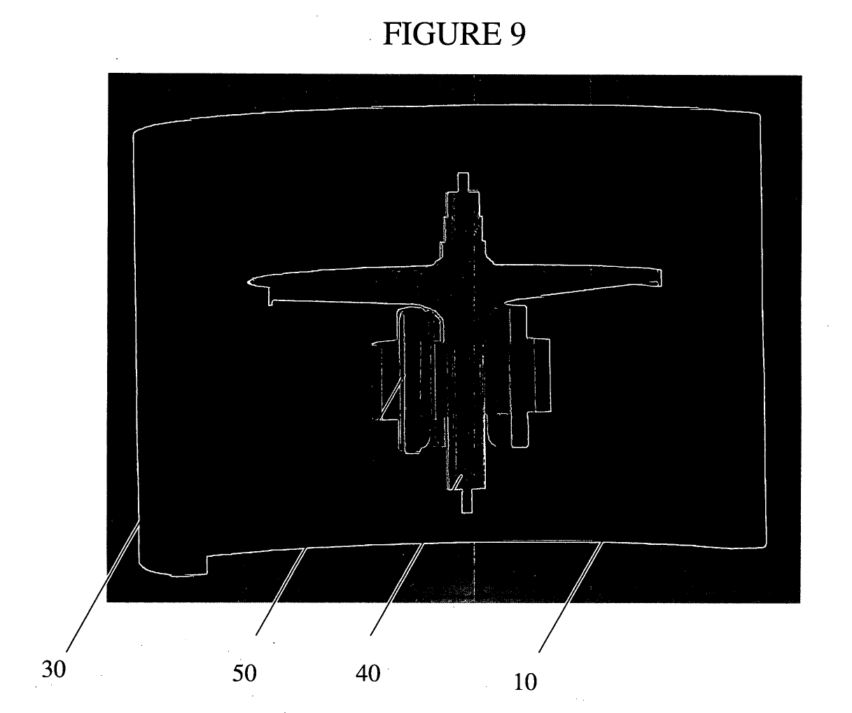

FIG. 4 is an isometric view of the composite rim mechanism 30. FIG. 5 is a cross-sectional view of the composite rim mechanism 30. FIG. 6 is an isometric cross sectional view of the shaft mechanism. FIG. 7 is an isometric cross sectional view of the hub 10, rim 30 and shaft mechanism 40. FIG. 9 is a side cutaway view of the overall system illustrating the hub 10, rim 30, shaft 40 and switched reluctance machine 50.

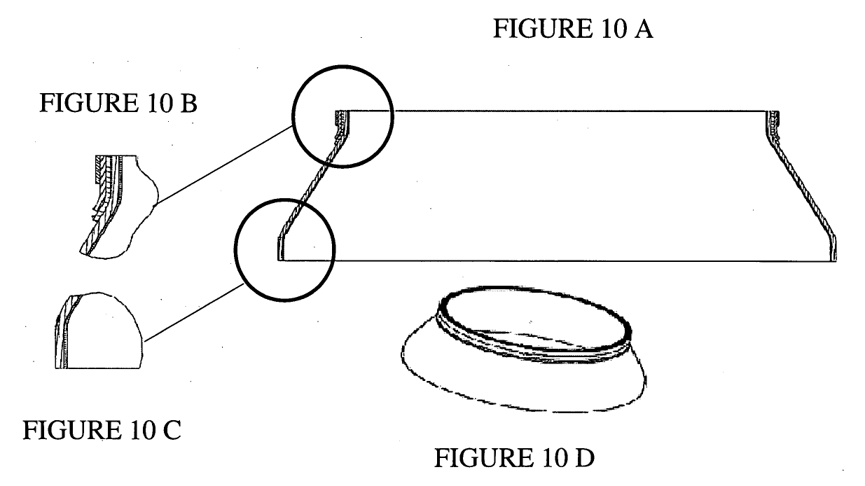

Additionally FIG. 10A is a side cutaway view of the overall hub. FIG. 10B is a side cross-section view of the upper cylindrical portion hub, illustrating the differing layers of the hub. FIG. 10C is a side cross-section view of the lower cylindrical portion hub, illustrating the differing layers of the hub. FIG. 10D is an isometric side view of the overall hub.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A flywheel rotor system comprising:
a composite hub mechanism;
a composite rim mechanism;
a shaft mechanism;
wherein said composite hub mechanism further comprises a plurality of portions comprising an upper substantially cylindrical portion, a median substantially conical portion and a lower substantially cylindrical portion; wherein said upper substantially cylindrical portion is in radial communication with said median substantially conical portion; wherein said median substantially conical portion is in radial communication with said lower substantially cylindrical portion.

2. The flywheel rotor system of claim 1 wherein each of said plurality of portions comprise a multiplicity of layers.

3. The flywheel rotor system of claim 2 wherein one of said multiplicity of layers comprises a carbon fiber/polyurethane prepreg tape with a fiber angle between plus 10 and minus 10 degrees.

4. The flywheel rotor system of claim 2 wherein a layer two of said multiplicity of layers comprises a film adhesive.

5. The flywheel rotor system of claim 2 wherein a layer three of said multiplicity of layers comprises a carbon fiber/polyurethane prepreg tape with a fiber volume of 67 percent and fiber angle between 80 degrees and 100 degrees.

6. The flywheel rotor system of claim 5 wherein a layer four of said multiplicity of layers comprises a carbon fiber/polyurethane prepreg tape with a fiber volume of sixty seven percent and fiber angle between 80 degrees and 100 degrees.

7. The flywheel rotor system of claim 6 wherein a layer five of said multiplicity of layers comprises a carbon fiber/polyurethane prepreg tape with a fiber volume of sixty seven percent and fiber angle of between 80 degrees and 100 degrees.

8. The flywheel rotor system of claim 7 wherein a layer six of said multiplicity of layers comprises a twenty ply, carbon fiber/polyurethane five mil prepreg tape with a fiber volume of sixty seven percent and fiber angle of between 80 and 100 degrees.

9. The flywheel rotor system of claim 3 wherein said layer one of said multiplicity of layers comprises a thickness of substantially 0.04 of an inch.

10. The flywheel rotor system of claim 4 wherein said layer two of said multiplicity of layers comprises a thickness of substantially 0.005 of an inch.

11. The flywheel rotor system of claim 6 wherein said layer three of said multiplicity of layers comprises a thickness of substantially 0.16 of an inch.

12. The flywheel rotor system of claim 7 wherein said layer four of said multiplicity of layers comprises a thickness of substantially 0.10 of an inch.

13. The flywheel rotor system of claim 8 wherein said layer five of said multiplicity of layers comprises a thickness of substantially 0.10 of an inch.

14. The flywheel rotor system of claim 9 wherein said layer six of said multiplicity of layers comprises a thickness of substantially 0.10 of an inch.

15. The flywheel rotor system of claim 1 wherein said first, second, third, fourth, fifth and sixth layers comprise a radial disposed between said upper substantially cylindrical portion and said median substantially conical portion.

16. The flywheel rotor system of claim 15 wherein said median portion comprises a 30 degree angle from a perpendicular.

17. The flywheel rotor system of claim 1 wherein said first, second and third layers comprise a radial section disposed between said median substantially conical portion and said lower substantially cylindrical portion.

18. The flywheel rotor system of claim 17 wherein said rotor achieves upper critical speeds 20 percent above the maximum operating speed of forty thousand revolutions per minute.

19. The flywheel rotor system of claim 17 wherein said rotor achieves lower critical speeds must be fifteen percent less than the lower operating speed of twenty thousand revolutions per minute.

20. The flywheel rotor system of claim 19 wherein said rotor achieves torsional resonances twenty percent above the maximum operating speed.

21. The flywheel rotor system of claim 20 wherein said rotor achieves a backward bending mode twenty percent above the maximum operating speed.

22. A composite flywheel rotor system comprising:
a composite hub mechanism comprising a plurality of sections comprising an upper substantially cylindrical portion, a median substantially conical portion and a lower substantially cylindrical portion; wherein a plurality of transition regions between said plurality of sections comprise radial disposed communication sections;
a composite rim mechanism;
a shaft mechanism;
wherein said composite hub mechanism is disposed to sustain a maximum strain substantially equal to a maximum strain at an inner diameter of said composite rim mechanism.

23. The composite flywheel rotor system of claim 22 wherein said composite hub mechanism further comprises a shallow cone angle between twenty degrees and forty degrees.

24. The composite flywheel rotor system of claim 23 wherein said composite hub mechanism further comprises nearly circumferential fibers.

25. The composite flywheel rotor system of claim 24 wherein said composite hub mechanism further comprises carbon fibers with a Polyurethane II resin.

26. The composite flywheel rotor system of claim 25 wherein said composite hub mechanism further comprises a radius ratio of less than two to one.

27. The composite flywheel rotor system of claim 26 wherein said rotor system comprises an energy density between eighty five and one hundred ten watt per hour kilograms.

28. The composite flywheel rotor system of claim 27 wherein said shaft is Titanium.

29. The composite flywheel rotor system of claim 22 wherein said composite hub mechanism is manufactured from a method of hand lay-up manufacturing comprising the steps of:
defining a matrix;
manufacturing a pre-impregnated tape;
cutting templates;
staggering material layers for butt joint considerations;
utilizing a vacuum debulk cycle every three layers to consolidate the layers, limit wrinkling and to alleviate void content;
autoclaving said hub apparatus;
curing said hub apparatus;
post-curing said hub apparatus;
trimming said hub apparatus; and,
performing a non destructive testing analysis.

30. The composite flywheel rotor system of claim 22 wherein said composite hub mechanism is manufactured from a method of resin transfer comprising the steps of:
placing a dry fabric into a closed mold;
transferring resin to create a braided perform hub geometry;
curing said braided perform hub geometry;
manufacturing a male tool and a female tool;
placing the braided perform hub onto a male tool;
locating the inlet, outlet and vent ports to limit porosity;
assembling said female tool onto said male tool to create a matched tooling system;
vacuum evacuating said matched tooling system;
injecting resin into said matched tooling system to create an interim hub geometry;
curing said interim hub geometry;
removing said interim hub geometry and post curing said interim hub geometry.
trimming said part; and,
performing a non destructive testing analysis.

31. The composite flywheel rotor system of claim 22 wherein said composite hub mechanism is manufactured from a wet filament winding method comprising the steps of:
utilizing control characteristics selected from the group consisting of fiber tension, resin wet out in bath and resin viscosity;
machining a mandrel outside diameter to control an inside diameter of said part;
spinning said mandrel in order to load a set of fiber on spools under tension through a resin bath;
controlling an applied tension upon said set of fiber in order not to squeeze resin from said set of fiber as said set of fiber loads on to said mandrel;
wherein said resin bath comprises spreadable rollers that work the resin into the fiber tow;
utilizing a filament winder which translates up and down said the axis of said mandrel, laying a desired fiber path to create a matrix;
curing said matrix in an oven while still positioned upon said mandrel to create said rim;
post curing said rim;
machining said rim; and,
inspecting said rim for compliance with standards.
